(19) United States
(12) Patent Application Publication
(10) Pub. No.: US 2025/0299135 A1
(43) Pub. Date: Sep. 25, 2025

(54) MECHANISM FOR AUTOMATED DETERMINATION AND EXCHANGE OF TRUST CREDENTIALS FOR COMPUTATIONAL DECISION SYSTEMS

(71) Applicant: Databricks, Inc., San Francisco, CA (US)

(72) Inventors: Abhiram Arikapudi, Sammamish, WA (US); Omar Farooq Khawaja, Vienna, VA (US); Arun Pamulapati, Ashburn, VA (US); David Lebrocq Veuve, San Francisco, CA (US)

(21) Appl. No.: 18/612,603

(22) Filed: Mar. 21, 2024

(51) Int. Cl. G06Q 10/0635

(52) U.S. Cl. CPC G06Q 10/0635

(57) ABSTRACT

A method for generating a trust credential for an AI-driven application is presented. The method includes identifying one or more risk factors, receiving a request to generate a trust credential for an AI-driven application, and receiving the AI-driven application and associated data, wherein the AI-driven application has one or more subcomponents. The method includes applying a risk determination function to each of the one or more subcomponents of the AI-driven application and the associated data to generate a risk score for each of the one or more subcomponents. The method further includes applying a weighting function to the risk score of each subcomponent to generate a trust score for each of the one or more subcomponents, and generating the trust credential for the AI-driven application based on the trust scores of each of the one or more subcomponents.

### TECHNICAL FIELD

This disclosure relates generally to generating trust credentials for software applications, and more specifically to, generating trust credentials for artificial intelligence (AI) and machine learning (ML) applications.

### BACKGROUND

In recent years, AI and ML applications have proliferated into numerous domains and industries, which has transformed the way tasks are performed. AI models are becoming fundamental and significant subcomponents of several software products, especially those offered under a Software as a Service (SaaS) model. However, widespread adoption of AI and ML applications is impeded by several challenges, including concerns regarding AI-specific risks, such as ethical issues, bias, transparency, morality, self-awareness, and more. However, a greater hurdle that AI and ML applications face is establishing trust. Thus, a method for assessing potential risks of an AI-driven application would be greatly advantageous for enterprise customers and developers.

### BRIEF DESCRIPTION OF THE DRAWINGS

FIG. 1 is a high-level block diagram of a system environment for a data processing service, in accordance with an embodiment.

FIG. 2 illustrates a block diagram of an architecture of a data storage system, in accordance with an embodiment.

FIG. 3 illustrates a block diagram of an architecture of a control layer, in accordance with an embodiment.

FIG. 4 illustrates a block diagram of an example risk scoring module including an example determination engine, in accordance with an embodiment.

FIG. 5 illustrates a block diagram of an example risk scoring module including an example credential generator, in accordance with an embodiment.

FIG. 6 is a flowchart illustrating a process for generating a trust credential for an AI-driven application, in accordance with an embodiment.

FIG. 7 is a block diagram illustrating an example machine to read and execute computer readable instructions, in accordance with an embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (computer-readable medium or method) for purposes of illustration only. One skilled in the art will readily recognize from the following description that alternative embodiments of the structures and methods illustrated herein may be employed without departing from the principles described herein.

### Overview

Embodiments of the present disclosure relates to a method for assessing the risk profile of an AI-driven application and generating a trust credential for the application. The method includes a data processing service, data storage system, and client devices communicatively coupled over a network. The data processing service may include a control layer and a data layer. The control layer may be configured to receive and process requests from the client devices and manage resources in the data layer. The control layer includes a risk scoring module which may be configured to identify one or more risk factors, generate a risk score for the AI-driven application by evaluating the application with respect to the one or more risk factors, and generating a trust credential for the AI-driven application in real time.

The risk scoring module may include a determination engine and a credential generator. The determination engine is configured to apply a risk determination function to the application and associated data to generate a risk score based on a set of risk factors. The credential generator receives the risk score from the determination engine and generates a trust credential based on the risk score and the source of the application. In some embodiments, the credential generator generates a standardized trust credential based on a standardized AI trust framework. This allows for the generation of a trust credential of an AI-driven application in real time, allowing a developer to build a secure and risk-averse application and allowing interested third-party entities to assess the risk profile of an application.

### Configuration

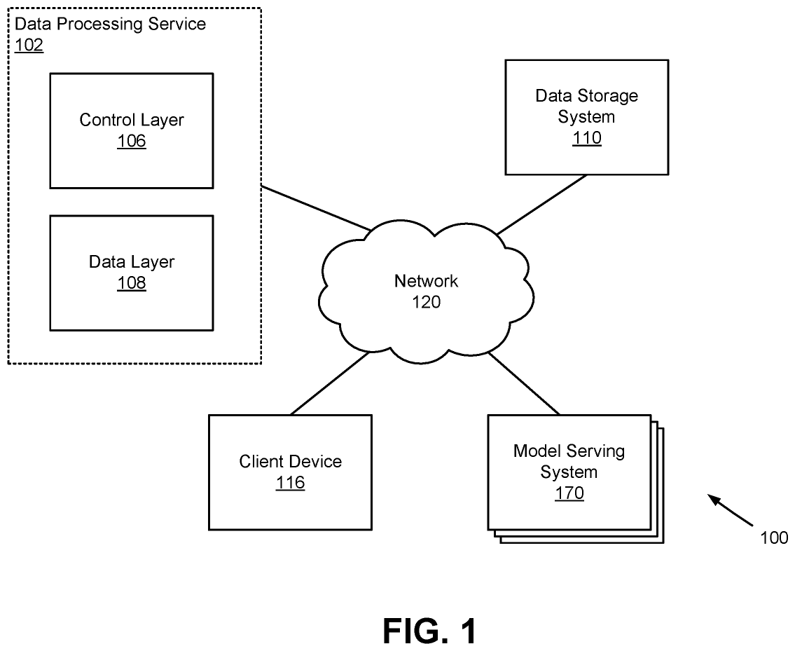

FIG. 1 is a high-level block diagram of a system environment 100 for a data processing service 102, in accordance with an embodiment. The system environment 100 shown by FIG. 1 includes one or more client devices 116, a network 120, a data processing service 102, and a data storage system 110. In alternative configurations, different and/or additional components may be included in the system environment 100.

The data processing service 102 is a service for managing and coordinating data processing services (e.g., database services) to users of client devices 116. The data processing service 102 may manage one or more applications that users of client devices 116 can use to communicate with the data processing service 102. Through an application of the data processing service 102, the data processing service 102 may receive requests (e.g., database queries) from users of client devices 116 to perform one or more data processing functionalities on data stored, for example, in the data storage system 110. The requests may include query requests, analytics requests, or machine learning (ML) and artificial intelligence (AI) requests, and the like, on data stored by the data storage system 110. For example, an ML or AI request may be a prompt for execution by one or more machine-learned models. The data processing service 102 may provide responses to the requests to the users of the client devices 116 after they have been processed.

In one embodiment, as shown in the system environment 100 of FIG. 1, the data processing service 102 includes a control layer 106 and a data layer 108. The components of the data processing service 102 may be configured by one or more servers and/or a cloud infrastructure platform. In one embodiment, the control layer 106 receives data processing requests and coordinates with the data layer 108 to process the requests from client devices 116. The control layer 106 may schedule one or more jobs for a request or receive requests to execute one or more jobs from the user directly through a respective client device 116. The control layer 106 may distribute the jobs to components of the data layer 108 where the jobs are executed.

The control layer 106 is additionally capable of configuring the clusters in the data layer 108 that are used for executing the jobs. For example, a user of a client device 116 may submit a request to the control layer 106 to perform one or more queries and may specify that four clusters on the data layer 108 be activated to process the request with certain memory requirements. Responsive to receiving this information, the control layer 106 may send instructions to the data layer 108 to activate the requested number of clusters and configure the clusters according to the requested memory requirements.

The data layer 108 includes multiple instances of clusters of computing resources that execute one or more jobs received from the control layer 106. Accordingly, the data layer 108 may include a cluster computing system for executing the jobs. In one instance, the clusters of computing resources are virtual machines or virtual data centers configured on a cloud infrastructure platform. In one instance, the control layer 106 is configured as a multi-tenant system and the data layers 108 of different tenants are isolated from each other. In one instance, a serverless implementation of the data layer 108 may be configured as a multi-tenant system with strong virtual machine (VM) level tenant isolation between the different tenants of the data processing service 102. Each customer represents a tenant of a multi-tenant system and shares software applications and also resources such as databases of the multi-tenant system. Each tenant's data is isolated and remains invisible to other tenants. For example, a respective data layer instance can be implemented for a respective tenant. However, it is appreciated that in other embodiments, single tenant architectures may be used.

The data layer 108 thus may be accessed by, for example, a developer through an application of the control layer 106 to execute code developed by the developer. In one embodiment, a cluster in a data layer 108 may include multiple worker nodes that execute multiple jobs in parallel. Responsive to receiving a request, the data layer 108 divides the cluster computing job into a set of worker jobs, provides each of the worker jobs to a worker node, receives worker job results, stores job results, and the like. The data layer 108 may include resources not available to a developer on a local development system, such as powerful computing resources to process very large data sets. In this manner, when the data processing request can be divided into jobs that can be executed in parallel, the data processing request can be processed and handled more efficiently with shorter response and processing time.

In one embodiment, the components of the data processing service 102 allows a user of the data processing service 102 to generate trust credentials of AI-driven applications in real time. The trust credential is a measure of the trustworthiness of the application and is routinely regenerated as the application evolves over time. The trust credential may be based on an industry standardized framework and can be provided to entities interested in using the application. For example, enterprise customers looking to integrate AI-driven Software as a Service (SaaS) applications into their business processes require a means for evaluating a risk profile of the application without having any visibility or understanding of the quality of the machine-learned models or algorithms used to develop the application. Furthermore, since AI-driven applications can constantly evolve from retraining an underlying model or modifying an underlying logic, it is essential to reevaluate the trustworthiness of the application.

It is a technically difficult problem to assess a risk profile for an AI-driven application and generate the trust credentials for AI-driven applications in real time. As described in more detail below, the data processing service 102 provides a system in which users can determine a risk score for an AI-driven application and generate a trust credential based on the risk score.

The model serving system 170 deploys one or more machine-learning models. The machine-learning models may include regression models, classification models, clustering models, neural networks, reinforcement learning models, or any suitable combination thereof.

In one instance, the machine-learning models are large language models (LLMs) that are trained on a large corpus of training data to generate outputs for tasks. An LLM may be trained on massive amounts of text data, often involving billions of words or text units. The large amount of training data from various data sources allows the LLM to generate outputs for many different types of tasks. An LLM may have a significant number of parameters in a deep neural network (e.g., transformer architecture), for example, at least 1 billion, at least 15 billion, at least 135 billion, at least 175 billion, at least 500 billion, at least 1 trillion, or at least 1.5 trillion parameters.

Since an LLM has significant parameter size and the amount of computational power for inference or training the LLM is high, the LLM may be trained and deployed or hosted on cloud infrastructure. An LLM may be trained on a large amount of data from various data sources, including websites, articles, posts on the web, and the like. From this massive amount of data coupled with the computing power of LLM's, the LLM can perform various tasks and synthesize responses based on information extracted from the training data. In one embodiment, the model serving system 170 is managed or may be part of the data processing service 102. In another embodiment, the model serving system 170 may be managed by another entity, and there may be different instances of the model serving system 170 deploying a respective model deployed by a respective entity.

In one embodiment, the model serving system 170 receives a request in the form of a prompt and generates a response to the prompt. The prompt or response may include text, images, audio, and the like and may be multi-modal. In one embodiment, the machine-learning model is configured as a transformer neural network architecture. Specifically, the transformer model is coupled to receive sequential data tokenized into a sequence of input tokens and generates a sequence of output tokens depending on the task to be performed when the model is an LLM. For example, the transformer may have a generative pre-training (GPT) architecture or may have an encoder-decoder architecture that include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, bi-directional encoder representation transformer (BERT), generative-adversarial networks (GAN), or diffusion models (e.g., Diffusion-LM).

The data storage system 110 includes a device (e.g., a disc drive, a hard drive, a semiconductor memory) used for storing database data (e.g., a stored data set, portion of a stored data set, data for executing a query). In one embodiment, the data storage system 110 includes a distributed storage system for storing data and may include a commercially provided distributed storage system service. Thus, the data storage system 110 may be managed by a separate entity than an entity that manages the data processing service 102 or a data management system may be managed by the same entity that manages the data processing service 102.

For example, when the data storage system 110 is managed by the entity managing the data processing service 102, the data storage system 110 may reside within the data layer 108. The data storage system 110 may include dedicated cloud storage for respective tenants of the data processing service 102. In another instance, the data storage system 110 may be external and/or remote to the data processing service 102 in that a different entity manages the data of the data storage system 110. For example, the data storage system 110 may be located in a remote location from the data processing service 102.

The client devices 116 are computing devices that display information to users and communicate user actions to the systems of the system environment 100. While two client devices 116 are illustrated in FIG. 1, in practice many client devices 116 may communicate with the systems of the system environment 100. In one embodiment, a client device 116 is a conventional computer system, such as a desktop or laptop computer. Alternatively, a client device 116 may be a device having computer functionality, such as a personal digital assistant (PDA), a mobile telephone, a smartphone or another suitable device. A client device 116 is configured to communicate via the network 120, which may comprise any combination of local area and/or wide area networks, using both wired and/or wireless communication systems.

In one embodiment, a client device 116 executes an application allowing a user of the client device 116 to interact with the various systems of the system environment 100 of FIG. 1. For example, a client device 116 can execute a browser application to enable interaction between the client device 116 and the data processing service 102 via the network 120. In another embodiment, the client device 116 interacts with the various systems of the system environment 100 through an application programming interface (API) running on a native operating system of the client device 116, such as IOS® or ANDROID™. In the system environment 100, only one client device 116 are shown for the sake of simplicity. However, it is appreciated that the system environment 100 may include many more client devices 116 connected to the network 120.

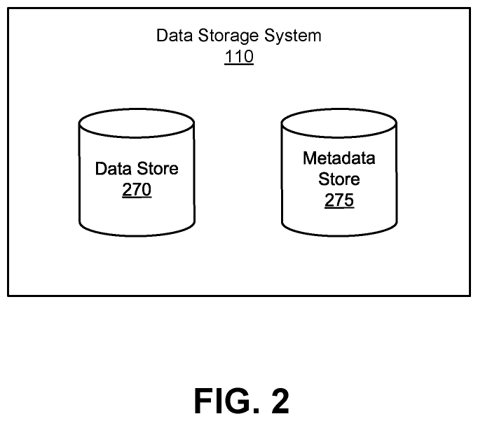

FIG. 2 is a block diagram of an architecture of a data storage system 110, in accordance with an embodiment. The data storage system 110 includes a data store 270 and a metadata store 275. In one embodiment, the data storage system 110 includes a data ingestion module (not pictured).

The data store 270 stores data associated with different tenants of the data processing service 102. In one embodiment, the data in data store 270 is stored in a format of a data table. A data table may include a plurality of records or instances, where each record may include values for one or more features. The records may span across multiple rows of the data table and the features may span across multiple columns of the data table. In other embodiments, the records may span across multiple columns and the features may span across multiple rows. For example, a data table associated with a security company may include a plurality of records each corresponding to a login instance of a respective user to a website, where each record includes values for a set of features including user login account, timestamp of attempted login, whether the login was successful, and the like. In one embodiment, the plurality of records of a data table may span across one or more data files. For example, a first subset of records for a data table may be included in a first data file and a second subset of records for the same data table may be included in another second data file.

In one embodiment, a data table may be stored in the data store 270 in conjunction with metadata stored in the metadata store 275. In one instance, the metadata includes transaction logs for data tables. Specifically, a transaction log for a respective data table is a log recording a sequence of transactions that were performed on the data table. A transaction may perform one or more changes to the data table that may include removal, modification, and additions of records and features to the data table, and the like. For example, a transaction may be initiated responsive to a request from a user of the client device 116. As another example, a transaction may be initiated according to policies of the data processing service 102. Thus, a transaction may write one or more changes to data tables stored in the data storage system 110.

In one embodiment, a new version of the data table is committed when changes of a respective transaction are successfully applied to the data table of the data storage system 110. Since a transaction may remove, modify, or add data files to the data table, a particular version of the data table in the transaction log may be defined with respect to the set of data files for the data table. For example, a first transaction may have created a first version of a data table defined by data files A and B each having information for a respective subset of records. A second transaction may have then created a second version of the data table defined by data files A, B and in addition, new data file C that include another respective subset of records (e.g., new records) of the data table.

In one embodiment, the transaction log may record each version of the table, the data files associated with a respective version of the data table, information pertaining to the type of transactions that were performed on the data table, the order in which the transactions were performed (e.g., transaction sequence number, a timestamp of the transaction), and an indication of data files that were subject to the transaction, and the like. In some embodiments, the transaction log may include change data for a transaction that also records the changes for data written into a data table with respect to the previous version of the data table. The change data may be at a relatively high level of granularity, and may indicate the specific changes to individual records with an indication of whether the record was inserted, deleted, or updated due to the corresponding transaction.

In some embodiments, the data storage system 110 stores data used for machine learning applications implemented by the control layer. The data storage system 110 may include a machine learning (ML) model server (not pictured) which stores ML models, versions of each of the ML models, and sets of parameters for the trained ML models. The ML model server may also store training data and testing data for training and testing the ML models. The ML model server may also store inputs and generated outputs of the ML models. In an embodiment, the ML models are developed by users of the data processing service 102, and training and testing data are provided (e.g., uploaded) by the users.

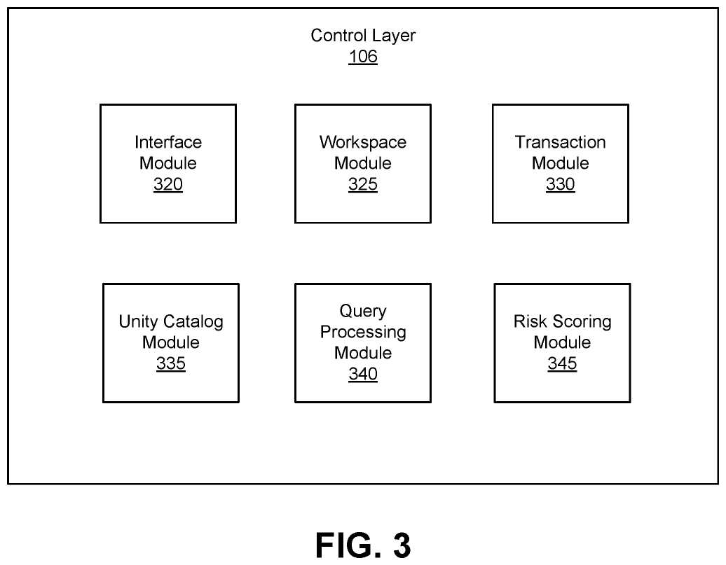

FIG. 3 is a block diagram of an architecture of a control layer 106, in accordance with an embodiment. In one embodiment, the data processing service 102 includes an interface module 320, a workspace module 325, a transaction module 330, a unity catalog module 335, a query processing module 340, a risk scoring module 345. The control layer 106 may also include a data notebook store.

The interface module 320 provides an interface and/or a workspace environment where users of client devices 116 (e.g., users associated with tenants) can access resources of the data processing service 102. For example, the user may retrieve information from data tables associated with a tenant, submit data processing requests such as query requests on the data tables, through the interface provided by the interface module 320. The interface provided by the interface module 320 may include notebooks, libraries, experiments, queries submitted by the user. In one embodiment, a user may access the workspace via a user interface (UI), a command line interface (CLI), or through an application programming interface (API) provided by the workspace module.

For example, a notebook associated with a workspace environment is a web-based interface to a document that includes runnable code, visualizations, and explanatory text. A user may submit data processing requests on data tables in the form of one or more notebook jobs. The user provides code for executing the one or more jobs and indications such as the desired time for execution, number of cluster worker nodes for the jobs, cluster configurations, a notebook version, input parameters, authentication information, output storage locations, or any other type of indications for executing the jobs. The user may also view or obtain results of executing the jobs via the workspace.

In an embodiment, the interface module 320 receives a request to generate a trust credential for an AI-driven application and provides the request to the risk scoring module 345. The interface module 320 may receive the generated trust credential from the risk scoring module 345 and generates a UI element that displays the trust credential to the requester.

The workspace module 325 deploys workspaces within the data processing service 102. A workspace as defined herein may refer to a deployment in the cloud that functions as an environment for users of the workspace to access assets. An account of the data processing service 102 represents a single entity that can include multiple workspaces. In one embodiment, an account associated with the data processing service 102 may be associated with one workspace. In another embodiment, an account may be associated with multiple workspaces. A workspace organizes objects, such as notebooks, libraries, dashboards, and experiments into folders. A workspace also provides users access to data objects, such as tables or views or functions, and computational resources such as cluster computing systems.

In one embodiment, a user or a group of users may be assigned to work in a workspace. The users assigned to a workspace may have varying degrees of access permissions to assets of the workspace. For example, an administrator of the data processing service 102 may configure access permissions such that users assigned to a respective workspace are able to access all the assets of the workspace. As another example, users associated with different subgroups may have different levels of access, for example users associated with a first subgroup may be granted access to all data objects while users associated with a second subgroup are granted access to only a select subset of data objects.

The transaction module 330 receives requests to perform one or more transaction operations from users of client devices 116. As described in conjunction in FIG. 2, a request to perform a transaction operation may represent one or more requested changes to a data table. For example, the transaction may be to insert new records into an existing data table, replace existing records in the data table, delete records in the data table. As another example, the transaction may be to rearrange or reorganize the records or the data files of a data table to, for example, improve the speed of operations, such as queries, on the data table. For example, when a particular version of a data table has a significant number of data files composing the data table, some operations may be relatively inefficient. Thus, a transaction operation may be a compaction operation that combines the records included in one or more data files into a single data file.

The unity catalog module 335 is a fine-grained governance solution for managing assets within the data processing service 102. It helps simplify security and governance by providing a central place to administer and audit data access. In one embodiment, the unity catalog module 335 maintains a metastore for a respective account. A metastore is a top-level container of objects for the account. The metastore may store data objects and the permissions that govern access to the objects. A metastore for an account can be assigned to one or more workspaces associated with the account. In one embodiment, the unity catalog module 335 organizes data as a three-level namespace, a catalogue is the first layer, a schema (also called a database) is the second layer, and tables and views are the third layer.

In one embodiment, the unity catalog module 335 enables read and write of data to data stored in cloud storage of the data storage system 110 on behalf of users associated with an account and/or workspace. In one instance, the unity catalog module 335 manages storage credentials and external locations. A storage credential represents an authentication and authorization mechanism for accessing data stored on the data storage system 110. Each storage credential may be subject to access-control policies that control which users and groups can access the credential. An external location is an object that combines a cloud storage path (e.g., storage path in the data storage system 110) with a storage credential that authorizes access to the cloud storage path. Each storage location is subject to access-control policies that control which users and groups can access the storage credential. Therefore, if a user does not have access to a storage credential in the unity catalog module 335, the unity catalog module 335 does not attempt to authenticate to the data storage system 110.

In one embodiment, the unity catalog module 335 allows users to share assets of a workspace and/or account with users of other accounts and/or workspaces. For example, users of Company A can configure certain tables owned by Company A that are stored in the data storage system 110 to be shared with users of Company B. Each organization may be associated with separate accounts on the data processing service 102. Specifically, a provider entity can share access to one or more tables of the provider with one or more recipient entities.

Responsive to receiving a request from a provider to share one or more tables (or other data objects), the unity catalog module 335 creates a share in the metastore of the provider. A share is a securable object registered in the metastore for a provider. A share contains tables and notebook files from the provider metastore that the provider would like to share with a recipient. A recipient object is an object that associates an organization with a credential or secure sharing identifier allowing that organization to access one or more shares of the provider. In one embodiment, a provider can define multiple recipients for a given metastore. The unity catalog module 335 in turn may create a provider object in the metastore of the recipient that stores information on the provider and the tables that the provider has shared with the recipient. In this manner, a user associated with a provider entity can securely share tables of the provider entity that are stored in a dedicated cloud storage location in the data storage system 110 with users of a recipient entity by configuring shared access in the metastore.

The query processing module 340 receives and processes queries that access data stored by the data storage system 110. The query processing module 340 may reside in the control layer 106. The queries processed by the query processing module 340 are referred to herein as database queries. The database queries are specified using a declarative database query language such as the SQL. The query processing module 340 compiles a database query specified using the declarative database query language to generate executable code that is executed. In one embodiment, the query processing module 340 provides one or more queries to appropriate clusters of the data layer 108, and receives responses to the queries from clusters in which the queries are executed.

The risk scoring module 345 generates a trust credential for AI-driven applications. The risk scoring module 345 receives a request from a user through the interface module 320 to generate a trust credential for an AI-driven application. The request may be made by a user developing the AI-driven application on the data processing service 102, or a third-party entity. The risk scoring module 345 receives the application and data associated with the application (e.g., datasets, machine-learned models, etc.). The risk scoring module 345 evaluates the application with respect to one or more risk factors by applying a risk determination function to the application and its associated data. The risk scoring module 345 generates a trust credential based on the results of the risk determination function. The risk scoring module 345 provides the generated trust credential to the interface module 320, which generates a UI element to display the trust credential to the user. In an embodiment, the risk scoring module 345 may generate a standardized trust credential based on a standardized scoring framework. The trust credential may be distributed to interested third party entities.

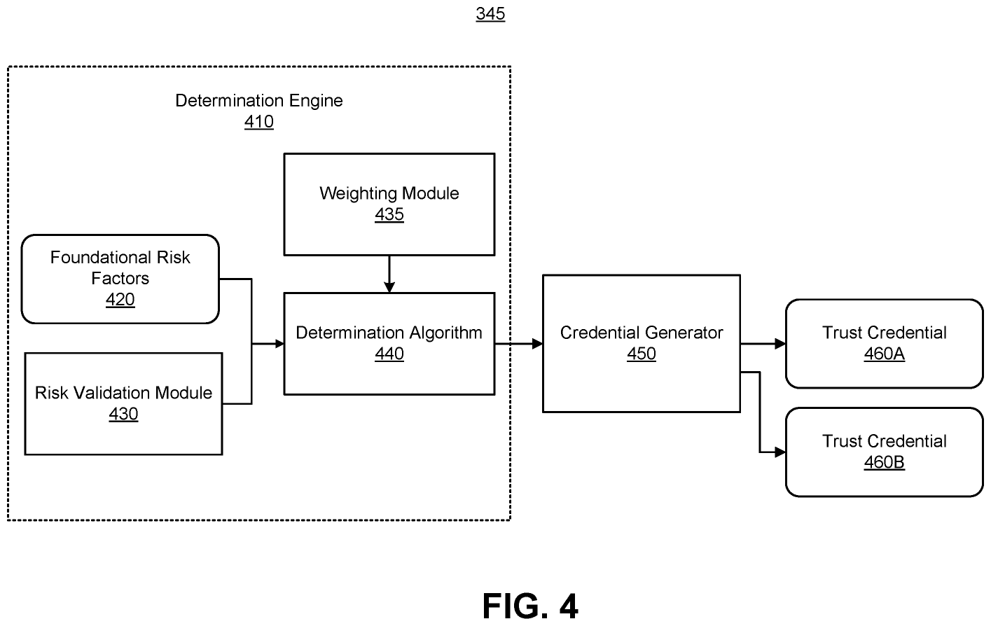

FIG. 4 illustrates a block diagram of an example risk scoring module including an example determination engine, in accordance with an embodiment. In some embodiments, AI-driven applications are developed using more than one subcomponent, which may be a software module designed to perform a specific function. Some examples of subcomponents may include a data preprocessing subcomponent, a model training subcomponent, a model evaluation subcomponent, etc.

The determination engine 410 is configured to generate a risk score for each subcomponent of the AI-driven application based on a set of risk factors. The determination engine 410 may include a risk validation module 430, a weighting module 435, and a determination algorithm 440. In alternative configurations, different and/or additional components may be included in the determination engine 410.

The set of risk factors relate to an application's inappropriate leverage or implementation of AI capabilities. The set of risk factors includes foundational risk factors 420, which are essential to the risk assessment of the application. The set of foundational risks factors 420 may include, but is not limited to, platform level risks, program risks, training persistence risks, inherited subcomponent risks, market considerations, de-anonymized industry benchmarks, and end-use applicability considerations. In an embodiment, the risk factors are selected by a human in the loop.

In other embodiments, the risk validation module 430 assesses new risk factors and adds them to the set of existing risk factors used to evaluate the application. The risk validation module 430 leverages a prescriptive analytics model to make determinations on whether a certain risk factor could be included in the foundational risk inventory. Inclusion determination is based on the risk factor indicator baseline meeting an adaptive probabilistic threshold. The indicator baseline for a risk factor is represented as:

$$B ( {RF}_{k} ) = \frac{P ( {RF}_{k} ) \times L ( {RF}_{k} )}{CE ( {RF}_{k} )}$$

where B(RF)ₖ represents Baseline value for a Risk Factor “k”, P being a function of prior indicators from related factors, L representing Likelihood of a factor being applicable to the model being evaluated and CE being the output from a Context Evaluation sub-model. The risk validation module 430 may also routinely assess the identified risk factors to determine if a risk factor should be removed from the set of existing risk factors.

The weighting module 435 determines the weighting factor corresponding to each risk factor. The weighting module determines the weighting factor by leveraging an additive model represented by:

$$R ( x ) = {\sum }_{i = 1}^{n} {W}_{i} {R}_{i} ( {x}_{i} )$$

where R(x) is the function of Risk Scoring, “n” is total number of Risk factors, “x” is the array of all Turst scoring criteria, Wi is the Weight of ith criteria, Rᵢ(xᵢ)=ith value of the Function. In addition, individual criteria Weights are determined via summation function represented by

W(RFₙ)=f{CE(RFₙ),P(RFₙ),PI(RFₙ)}

where the Weight of the n^{th} Risk Factor W(RFₙ) is a function on Context Evaluation score (CE), Probability rating (P) and Prior Impact rating (PI) of the given Factor.

The determination algorithm 440 generates a risk score of the subcomponent. In an embodiment, the determination algorithm 440 includes a scanner subcomponent which receives and scans the code and data associated to the subcomponent to extract data related to the set of risk factors, and which influences the generated risk score. For example, the scanner module may extract data associated with the configuration of the application, data handling practices, and source of the subcomponent (e.g., developed by a certified source). The determination algorithm 440 analyzes the extracted data and applies a risk determination function to the extracted data to compute a risk factor value for each risk factor. The risk determination function may generate a quantitative (e.g., numerical measures) and/or qualitative (e.g., descriptive terms) result. For example, the risk determination function may compute numerical values associated with each risk factor (e.g., risk factor values) based on the data extracted by the scanning module, such as the number of occurrences of the risk, a value indicating the presence of the risk, and a severity score of the risk present.

For example, consider computing a risk factor value for a risk factor associated with the quality of a publicly available training dataset that was used to train an ML model implemented by the subcomponent. The scanner module receives and scans data from the training dataset. The scanner module may extract data associated with the quality of the dataset (e.g., clean or noisy). The determination algorithm 440 applies the risk determination function to the extracted data and computes a risk factor value for the risk factor. Accordingly, the risk factor value of the publicly available training dataset may be higher if the quality of the data is poor. In this example, a higher risk factor indicates that the identified risk is significant. In another example, consider computing a risk factor value for a risk factor associated with the inappropriate use of an algorithm in the application. The scanning module of the determination algorithm 440 may scan the code of a subcomponent and identify that a linear regression model is used to develop a computer vision application. Accordingly, this may result in a higher risk factor value for using a model unsuitable for the purpose of the application.

In other embodiments, the risk determination function may use contextual methods and data driven methods to evaluate the subcomponent with respect to the set of risk factors.

The risk determination function generates a risk score for the subcomponent based on the computed weighted risk factor values. The risk determination function applies each weighting factor determined by the weighting module 435 to the corresponding risk factor values to compute weighted risk factor values. The risk determination function may aggregate the weighted risk factor values to generate a risk score for the subcomponent.

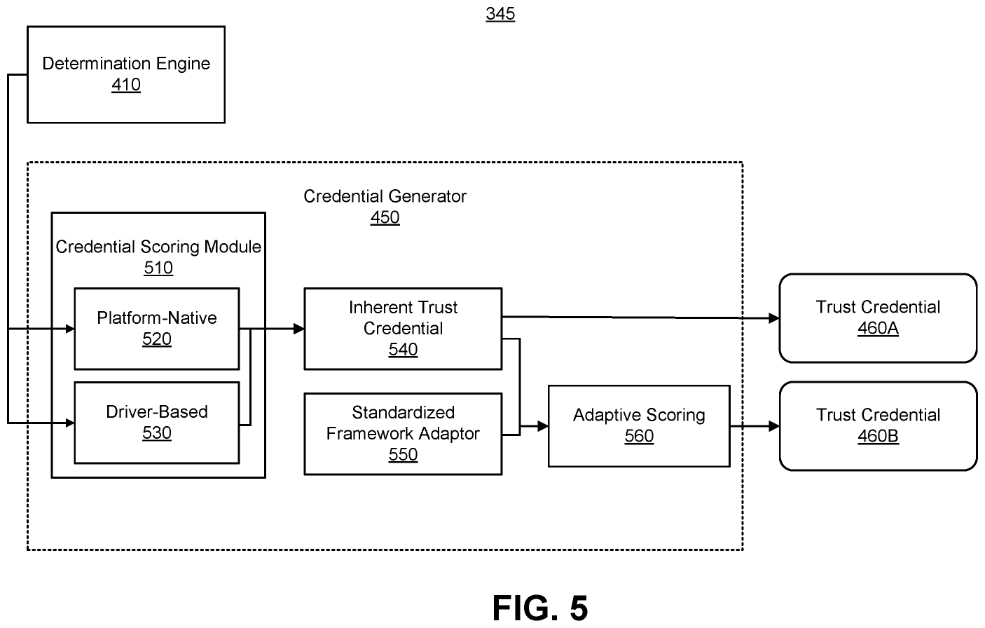

FIG. 5 illustrates a block diagram of an example risk scoring module including an example credential generator, in accordance with an embodiment. The credential generator 450 is configured to generate trust credentials for a subcomponent or an AI-driven application. The credential generator 450 includes a credential scoring module 510, a standardized framework adaptor 550, and adaptive scoring module 560.

The credential scoring module 510 generates an inherent trust credential 540 for the AI-driven application based on the risk scores of the subcomponents of the application. The credential scoring module 510 receives the risk scores of the subcomponents of the application generated by the determination engine, and the source of each subcomponent. As described in FIG. 4, the scanning module scans and extracts data from the code and data associated with the subcomponent, such as the source of the subcomponent. The credential scoring module 510 applies a weighting function to a risk score based on the source of the subcomponent to compute a trust score for the subcomponent.

The credential scoring module 510 analyzes the source of the subcomponent and classifies the subcomponent as platform-native 520 or driver-based 530. The subcomponent is classified as platform-native 520 if the subcomponent is from a certified source, while the subcomponent is classified as driver-based if the subcomponent is from a non-certified source. For example, a subcomponent is categorized as platform-native 520 if it was developed on the data processing service 102, which is a certified source. Whereas a subcomponent may be categorized as driver-based 530 if it was developed on a third-party platform, which is a non-certified source, and requires drivers to integrate the subcomponent to the data processing service 102. In some embodiments, a third-party source or platform may be considered a certified source.

The weighting function applies a larger weight to the risk score of a platform-native 520 subcomponent, while the weighting function applies a smaller weight to the risk score of a driver-based 530 subcomponent. In this example, a larger weight indicates greater trustworthiness, and a smaller weight indicates that the subcomponent is less trustworthy.

In some embodiments, the credential scoring module 510 computes the inherent trust credential 540 for the AI-driven application by aggregating the trust scores for each subcomponent of the application. The inherent trust credential is a raw, unstandardized score that is used for calculations performed by the risk scoring module 345. The trust credential 460A may be generated from the inherent trust credential 540 and shared with other users or a third-party entity.

The standardized framework adaptor 550 includes conversion functions to convert the inherent trust credential 540 to a standardized trust credential. A user can choose to generate a trust credential based on various standardized AI trust frameworks. The standardized framework adaptor 550 will continue to evolve with scoring logic to convert inherent credential values to any new regulatory or industry-standard scoring mechanisms.

The adaptive scoring module 560 applies the selected conversion function to the inherent trust credential 540 to generate a standardized trust credential 460B. The trust credentials 460A, 460B may be shared with a third-party entity through a credential exchange protocol.

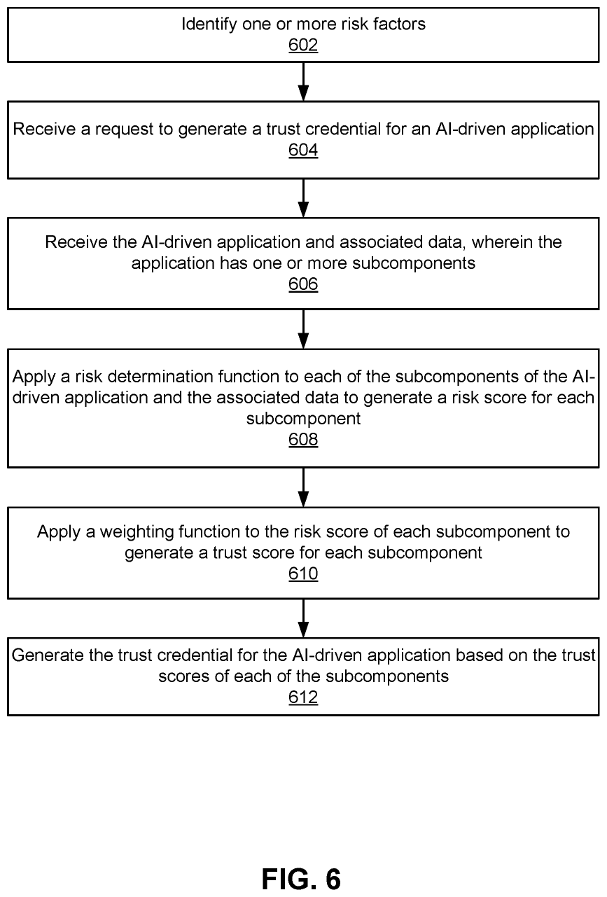

FIG. 6 is a flowchart illustrating a process for generating a trust credential for an AI-driven application, in accordance with an embodiment. The risk scoring module identifies 602 one or more risk factors. Identifying the one or more risk factors may include leveraging a prescriptive analytics model to make determinations on whether a certain risk factor could be included in the foundational risk inventory. An adaptive probabilistic threshold dynamically determines both the inclusion and exclusion of risk factors. As described in FIG. 4, the risk scoring module may access an AI-driven application for inappropriate leverage or implementation of AI capabilities based on the set of one or more risk factors. The risk scoring module routinely assesses new and existing risk factors to be added or removed from the set of risk factors. The risk scoring module receives 604 a request to generate a trust credential for the AI-driven application. The request may be received from a user of the data processing service 102 or a third-party platform. The risk scoring module receives 606 the AI-driven application and associated data, wherein the application has one or more subcomponents.

The risk scoring module applies 608 a risk determination function to each of the subcomponents of the AI-driven application to generate a risk score for each of the subcomponents. As described in FIG. 4, the risk determination function includes determining a risk factor value associated with each risk factor, and determining a weight for each of the risk factors. The risk determination function further includes applying a corresponding weight to each of the risk factor values to generate a weighted risk factor value, and compute the risk score of the subcomponent based on the weighted risk factor values. In some embodiments, the risk determination function computes the risk score by aggregating the weighted risk factor values.

The risk scoring module applies 610 a weighting function to the risk score of each subcomponent to generate a trust score for each subcomponent. The weighting function applies a weight based on the source of the subcomponent. The risk scoring module generates 612 the trust credential for the AI-driven application based on the trust scores of each subcomponent. In some embodiments, a standardized trust credential is generated based on the trust credential and a standardized AI trust framework. For example, a trust credential for a machine-learning application may include validating risks relevant to model-type, evaluating applicability of risk factor, determining model susceptibility to each applicable risk, and aggregating residual risk impact values. Further, generating the trust score for the machine-learning application may include collating the trust credential using a standardized framework-based scoring (e.g., NIST) to create a finalized adaptive trust score.

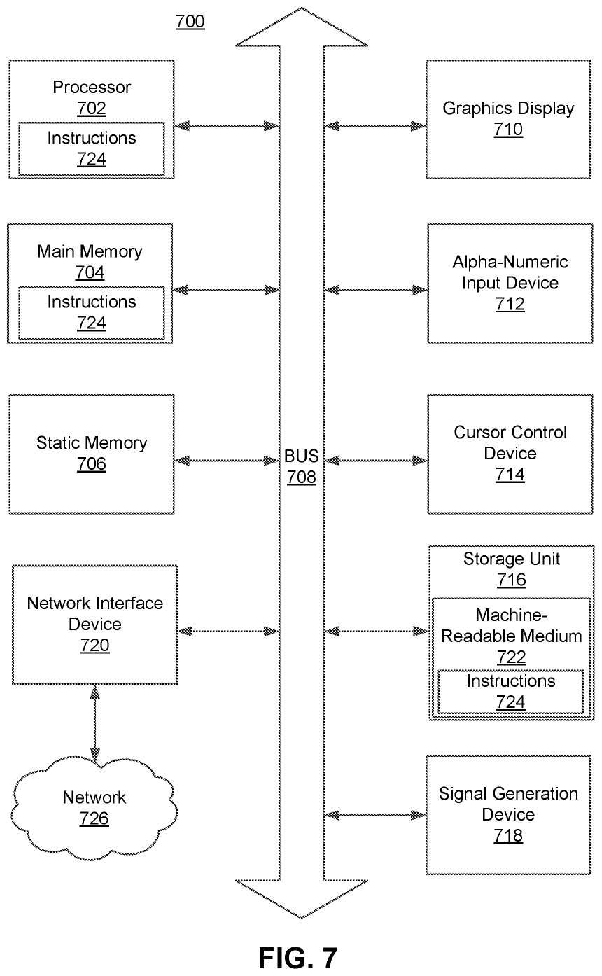

Turning now to FIG. 7, illustrated is an example machine to read and execute computer readable instructions, in accordance with an embodiment. Specifically, FIG. 7 shows a diagrammatic representation of the data processing service 102 (and/or data processing system) in the example form of a computer system 700. The computer system 700 can be used to execute instructions 724 (e.g., program code or software) for causing the machine to perform any one or more of the methodologies (or processes) described herein. In alternative embodiments, the machine operates as a standalone device or a connected (e.g., networked) device that connects to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a smartphone, an internet of things (IoT) appliance, a network router, switch or bridge, or any machine capable of executing instructions 724 (sequential or otherwise) that specify actions to be taken by that machine. Further, while only a single machine is illustrated, the term “machine” shall also be taken to include any collection of machines that individually or jointly execute instructions 724 to perform any one or more of the methodologies discussed herein.

The example computer system 700 includes a processing system including one or more processing units (generally processor 702). The processor 702 is, for example, a central processing unit (CPU), a graphics processing unit (GPU), a digital signal processor (DSP), a controller, a state machine, one or more application specific integrated circuits (ASICs), one or more radio-frequency integrated circuits (RFICs), or any combination of these. The processor executes an operating system for the computing system 700. The computer system 700 also includes a main memory 704. In some embodiments, the main memory 704 is a memory system including one or more memories. The computer system may include a storage unit 716. The processor 702, memory 704, and the storage unit 716 communicate via a bus 708.

In addition, the computer system 700 can include a static memory 706, a graphics display 710 (e.g., to drive a plasma display panel (PDP), a liquid crystal display (LCD), or a projector). The computer system 700 may also include alphanumeric input device 712 (e.g., a keyboard), a cursor control device 714 (e.g., a mouse, a trackball, a joystick, a motion sensor, or other pointing instrument), a signal generation device 718 (e.g., a speaker), and a network interface device 720, which also are configured to communicate via the bus 708.

The storage unit 716 includes a machine-readable medium 722 on which is stored instructions 724 (e.g., software) embodying any one or more of the methodologies or functions described herein. For example, the instructions 724 may include instructions for implementing the functionalities of the transaction module 330 and/or the file management module. The instructions 724 may also reside, completely or at least partially, within the main memory 704 or within the processor 702 (e.g., within a processor's cache memory) during execution thereof by the computer system 700, the main memory 704 and the processor 702 also constituting machine-readable media. The instructions 724 may be transmitted or received over a network 726, such as the network 120, via the network interface device 720.

While machine-readable medium 722 is shown in an example embodiment to be a single medium, the term “machine-readable medium” should be taken to include a single medium or multiple media (e.g., a centralized or distributed database, or associated caches and servers) able to store the instructions 724. The term “machine-readable medium” shall also be taken to include any medium that is capable of storing instructions 724 for execution by the machine and that cause the machine to perform any one or more of the methodologies disclosed herein. The term “machine-readable medium” includes, but not be limited to, data repositories in the form of solid-state memories, optical media, and magnetic media.

### Additional Configuration Considerations

The disclosed configuration beneficially enables enterprises consume AI-driven software by removing the need to separately assess risk profiles of such products, and allow for leverage of AI-drive software within key business critical functions of the enterprise. a credential scoring mechanism into a cloud environment artificial intelligence modeling system to enable a trust credential. The trust credential may be used to provide a guardrail to help develop secure/risk-averse models by enabling insights into which parts of their build was responsible for a lower score.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

While particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined herein.

What is claimed is:

1. A method, comprising:
identifying one or more risk factors;
receiving a request to generate a trust credential for a machine-learning application;
receiving the machine-learning application and associated data, wherein the machine-learning application has one or more subcomponents;
applying a risk determination function to each of the one or more subcomponents of the machine-learning application and the associated data to generate a risk score for each of the one or more subcomponents, wherein the risk determination function evaluates the one or more subcomponents of the machine-learning application with respect to the one or more risk factors;
applying a weighting function to the risk score of each subcomponent to generate a trust score for each of the one or more subcomponents, wherein the weighting function applies a weight to a risk score based on a source of a subcomponent of the machine-learning application; and
generating the trust credential for the machine-learning application based on the trust scores of each of the one or more subcomponents.

2. The method of claim 1, wherein identifying the one or more risk factors comprises leveraging a prescriptive analytics model to determine whether a risk factor may be a foundational risk.

3. The method of claim 1, wherein applying the risk determination function to a subcomponent of the machine-learning application and the associated data to generate a risk score for the subcomponent comprises:
determining a risk factor value associated with each of the one or more risk factors;
determining a weight for each of the one or more risk factors;
applying a corresponding weight to each of the risk factor values to generate weighted risk factor values; and
computing the risk score of the subcomponent based on the weighted risk factor values.

4. The method of claim 1, wherein a subcomponent is a software module configured to perform a specific function.

5. The method of claim 1, wherein each of the one or more risk factors are assigned weights based on an adaptive combination of numerical context evaluation, probabilistic rating value, and deterministic impact rating based on prior occurrences.

6. The method of claim 1, wherein the weighting function applies a smaller weight to a risk score corresponding to a subcomponent from a non-certified source, and applies a greater weight to a risk score corresponding to a subcomponent from a certified source.

7. The method of claim 1, wherein generating a trust credential for the machine-learning application comprises:
validating risks relevant to model-type;
evaluating applicability of risk factor;
determining model susceptibility to each applicable risk; and
aggregating residual risk impact values.

8. The method of claim 5, wherein generating the trust score for the machine-learning application further comprises of collating the trust credential a standardized framework-based scoring to create a finalized adaptive trust score.

9. The method of claim 1, further comprising:
applying a conversion function to the trust credential of the machine-learning application to generate a standardized trust credential.

10. A non-transitory computer-readable medium comprising stored instructions that, when executed by a processor system, cause the processor system to:
identify one or more risk factors;
receive a request to generate a trust credential for a machine-learning application;
receive the machine-learning application and associated data, wherein the machine-learning application has one or more subcomponents;
apply a risk determination function to each of the one or more subcomponents of the machine-learning application and the associated data to generate a risk score for each of the one or more subcomponents, wherein the risk determination function evaluates the one or more subcomponents of the machine-learning application with respect to the one or more risk factors;
apply a weighting function to the risk score of each subcomponent to generate a trust score for each of the one or more subcomponents, wherein the weighting function applies a weight to a risk score based on a source of a subcomponent of the machine-learning application; and
generate the trust credential for the machine-learning application based on the trust scores of each of the one or more subcomponents.

11. The non-transitory computer-readable medium of claim 10, the instructions to identify one or more risk factors further comprises instructions that, when executed by the processor system, cause the processor system to leverage a prescriptive analytics model to determine whether a risk factor may be a foundational risk.

12. The non-transitory computer-readable medium of claim 10, the instructions to apply the risk determination function to a subcomponent of the machine-learning application and the associated data to generate a risk score for the subcomponent further comprises instructions that, when executed by the processor system, cause the processor system to:
determine a risk factor value associated with each of the one or more risk factors;
determine a weight for each of the one or more risk factors;
apply a corresponding weight to each of the risk factor values to generate weighted risk factor values; and
compute the risk score of the subcomponent based on the weighted risk factor values.

13. The non-transitory computer-readable medium of claim 10, wherein each of the one or more risk factors are assigned weights based on an adaptive combination of numerical context evaluation, probabilistic rating value, and deterministic impact rating based on prior occurrences.

14. The non-transitory computer-readable medium of claim 10, wherein the weighting function applies a smaller weight to a risk score corresponding to a subcomponent from a non-certified source and applies a higher weight to a risk score corresponding to a subcomponent from a certified source.

15. The non-transitory computer-readable medium of claim 10, the instructions to generate a trust score for the machine-learning application further comprises instructions that, when executed by the processor system, cause the processor system to:
validate risks relevant to model-type;
evaluate applicability of risk factor;
determine model susceptibility to each applicable risk; and
aggregate residual risk impact values.

16. The non-transitory computer-readable medium of claim 14, the instructions to generate the trust score for the machine-learning application further comprises instructions that, when executed by the processor system, cause the processor system to collate the trust credential a standardized framework-based scoring to create a finalized adaptive trust score.

17. The non-transitory computer-readable medium of claim 10, further comprising instructions that, when executed by the processor system, cause the processor system to:
apply a conversion function to the trust credential of the machine-learning application to generate a standardized trust credential.

18. A computer system, comprising:
a processor system, and
a memory system comprising stored instructions that when executed by the processor system causes the computer system to:
identify one or more risk factors;
receive a request to generate a trust credential for a machine-learning application;
receive the machine-learning application and associated data, wherein the machine-learning application has one or more subcomponents;
apply a risk determination function to each of the one or more subcomponents of the machine-learning application and the associated data to generate a risk score for each of the one or more subcomponents, wherein the risk determination function evaluates the one or more subcomponents of the machine-learning application with respect to the one or more risk factors;
apply a weighting function to the risk score of each subcomponent to generate a trust score for each of the one or more subcomponents, wherein the weighting function applies a weight to a risk score based on a source of a subcomponent of the machine-learning application; and
generate the trust credential for the machine-learning application based on the trust scores of each of the one or more subcomponents.

19. The computer system of claim 18, the instructions to identify one or more risk factors further comprises instructions that, when executed by the processor system, cause the processor system toleverage a prescriptive analytics model to determine whether a risk factor may be a foundational risk.

20. The computer system of claim 18, the instructions to apply the risk determination function to a subcomponent of the machine-learning application and the associated data to generate a risk score for the subcomponent further comprises instructions that, when executed by the processor system, cause the processor system to:
determine a risk factor value associated with each of the one or more risk factors;
determine a weight for each of the one or more risk factors;
apply a corresponding weight to each of the risk factor values to generate weighted risk factor values; and
compute the risk score of the subcomponent based on the weighted risk factor values.
